(19) United States
(12) Patent Application Publication
(10) Pub. No.: US 2013/0082834 A1
(43) Pub. Date: Apr. 4, 2013

(54) OPERATION STATUS MONITORING APPARATUS AND OPERATION STATUS MONITORING METHOD

(71) Applicants: Shinichi Nagai, Musashino-shi (JP); Yasunori Kobayashi, Musashino-shi (JP)

(72) Inventors: Shinichi Nagai, Musashino-shi (JP); Yasunori Kobayashi, Musashino-shi (JP)

(73) Assignee: YOKOGAWA ELECTRIC CORPORATION, Tokyo (JP)

(21) Appl. No.: 13/606,234

(22) Filed: Sep. 7, 2012

(30) Foreign Application Priority Data
Sep. 29, 2011 (JP) 2011-214453

(51) Int. Cl. G08B 21/18

(52) U.S. Cl. 340/521

(57) ABSTRACT

An operation status monitoring apparatus for monitoring an operation status of a plant via a display screen, includes: an inflow acquisition unit that acquires an amount of material or heat flowing into a predetermined region of plant facilities, an outflow acquisition unit that acquires an amount of material or heat flowing out of the predetermined region, a calculation unit that calculates a balance between an amount of material acquired by the inflow acquisition unit and an amount of material acquired by the outflow acquisition unit or a balance between an amount of heat acquired by the inflow acquisition unit and an amount of heat acquired by the outflow acquisition unit, and a display means that graphically displays the balance calculated by the calculation unit on a display screen.

### CROSS-REFERENCE TO RELATED APPLICATION

This application claims the benefit of priority of Japanese Application No. 2011-214453, filed Sep. 29, 2011, the entire contents of which are incorporated herein by reference.

### BACKGROUND

1. Technical Field

The present disclosure relates to an operation status monitoring apparatus and the like for monitoring the operation status of a plant via a display screen.

2. Related Art

A display screen of an operation monitoring apparatus that monitors the operation status of a plant generally displays various plant information and operation information such as (1) flow processes, (2) measurement points (tag names) such as an amount of flow, temperature, and the like, and their current values, (3) operation status of pumps, and (4) abnormal value warnings (alarms).

An operator ascertains the plant status based on the status of and changes in individual variables such as changes in individual data that is displayed and trend graphs displayed separate from the data, abnormal tags and abnormal values for which an alarm is displayed, and the like. The operator makes a judgment in response to such conditions and operates the plant based on such a judgment.

In a plant control monitoring apparatus disclosed in Japanese Patent No. 3,848,920, the operation statuses of devices, equipment, and processes included in the plant are displayed. Thereby, the plant can be controlled and monitored.

### SUMMARY

An operation status monitoring apparatus for monitoring an operation status of a plant via a display screen, includes: an inflow acquisition means that acquires an amount of material or heat flowing into a predetermined region of plant facilities, an outflow acquisition means that acquires an amount of material or heat flowing out of the predetermined region, a calculation means that calculates a balance between an amount of material acquired by the inflow acquisition means and an amount of material acquired by the outflow acquisition means or a balance between an amount of heat acquired by the inflow acquisition means and an amount of heat acquired by the outflow acquisition means, and a display means that graphically displays the balance calculated by the calculation means on a display screen.

### BRIEF DESCRIPTION OF THE DRAWINGS

FIG. 1 is a block diagram illustrating a constitution of an operation status monitoring apparatus according to a first embodiment.

FIG. 2 is a diagram illustrating an example of a constitution (process flow) of a portion of plant facilities.

FIG. 3 is a diagram illustrating an example of a portion of plant facilities graphically displayed on a display screen.

FIG. 4 is a flow chart illustrating the operation of an operation monitoring apparatus relating to a calculation and display of a balance between an amount of inflow material and outflow material.

FIGS. 5A and 5B are diagrams illustrating a graphical display. FIG. 5A is a diagram illustrating an example of graphical displays displayed in various regions of a display screen. FIG. 5B is a diagram illustrating a display status of a trend graph when a reset button is operated.

FIG. 6 is a diagram illustrating an example of a constitution (process flow) of a portion of plant facilities.

FIGS. 7A and 7B are diagrams illustrating a graphical display. FIG. 7A is a diagram illustrating an example of the graphical displays displayed in a plurality of regions of a display screen. FIG. 7B is a diagram illustrating a display status of a trend graph when a reset button is operated.

FIG. 8 is a diagram illustrating an example of another graphical display showing a balance between an amount of inflow material and outflow material.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In a large-scale plant, it is difficult to display all of the plant facilities on one display screen in an operation monitoring apparatus. In this case, in the operation monitoring apparatus, the plant facilities are divided and displayed in accordance with a process flow. However, in a divided screen in accordance with the process flow, a tag corresponding to a measurement result of a feed flow amount entering a certain device and a flow amount discharged from the device to the outside of the system may not be displayed on the same screen as the device. Therefore, there has been a problem in that it is difficult to ascertain a balance between an amount of inflow material and outflow material of the device on a divided screen. Further, even if the parameters used for ascertaining the material balance are displayed on the same screen, it is difficult to ascertain the material balance based on the display screen. In addition, if an abnormality occurs in the material accumulation in the device, the operator is alerted as, for example, a drum level abnormality. However, if the drum level gauge that measures the hydrocarbon amount in the drum breaks down or malfunctions, abnormalities in the material balance such as hydrocarbon accumulation in the drum may not be ascertained. Further, for the same reasons, it is difficult to ascertain the heat balance for a certain device or system in a conventional operation monitoring apparatus.

An object of the present disclosure is to provide an operation status monitoring apparatus in which the material balance or the heat balance can be easily ascertained.

An operation status monitoring apparatus for monitoring an operation status of a plant via a display screen according to the present disclosure, includes: an inflow acquisition means that acquires an amount of material or heat flowing into a predetermined region of plant facilities, an outflow acquisition means that acquires an amount of material or heat flowing out of the predetermined region, a calculation means that calculates a balance between an amount of material acquired by the inflow acquisition means and an amount of material acquired by the outflow acquisition means or a balance between an amount of heat acquired by the inflow acquisition means and an amount of heat acquired by the outflow acquisition means, and a display means that graphically displays the balance calculated by the calculation means on a display screen.

According to the above-described operation status monitoring apparatus, a balance between the amount of material acquired by the inflow acquisition means and the amount of material acquired by the outflow acquisition means is calculated, or a balance between the amount of heat acquired by the inflow acquisition means and the amount of heat acquired by the outflow acquisition means is calculated. The calculated balance is graphically displayed on the display screen. Therefore, the material balance or the heat balance can be easily ascertained.

The calculation means can also calculate as the balance an integrated value of the difference between the amount of material acquired by the inflow acquisition means and the amount of material acquired by the outflow acquisition means, or an integrated value of the difference between the amount of heat acquired by the inflow acquisition means and the amount of heat acquired by the outflow acquisition means.

The operation status monitoring apparatus can further include a reset accepting means that accepts an instruction for resetting the calculation means so that the current value of the integrated value becomes zero.

The calculation means can continuously calculate the balance, and the display means can graphically display a trend of the balance that is calculated by the calculation means.

The display means can align a facility in the predetermined region among the plant facilities next to the balance, or overlay the facility in the predetermined region over the balance, and graphically display them on the display screen.

The operation status monitoring apparatus can further include a region accepting means that accepts an instruction that sets the predetermined region via an operation on a graphical display of the plant facilities displayed on the display screen.

An operation status monitoring method according to the present disclosure is an operation status monitoring method for monitoring an operation status of a plant using a display screen. The operation status monitoring method includes the following steps executed by a computer: an inflow acquisition step for acquiring an amount of material or heat flowing into a predetermined region of plant facilities, an outflow acquisition step for acquiring an amount of material or heat flowing out of the predetermined region, a calculation step for calculating a balance between an amount of material acquired in the inflow acquisition step and an amount of material acquired in the outflow acquisition step or a balance between an amount of heat acquired in the inflow acquisition step and an amount of heat acquired in the outflow acquisition step, and a display step for graphically displaying the balance calculated in the calculation step on a display screen.

According to the above-described operation status monitoring method, a balance between the amount of material acquired by the inflow acquisition means and the amount of material acquired by the outflow acquisition means is calculated, or a balance between the amount of heat acquired by the inflow acquisition means and the amount of heat acquired by the outflow acquisition means is calculated. The calculated balances are graphically displayed on the display screen. Therefore, the material balance or the heat balance can be easily ascertained.

In the calculating step, an integrated value of the difference between the amount of material acquired by the inflow acquisition means and the amount of material acquired by the outflow acquisition means, or an integrated value of the difference between the amount of heat acquired by the inflow acquisition means and the amount of heat acquired by the outflow acquisition means can also be calculated as the balance.

According to the operation status monitoring apparatus of the present disclosure, a balance between the amount of material acquired by the inflow acquisition means and the amount of material acquired by the outflow acquisition means is calculated, or a balance between the amount of heat acquired by the inflow acquisition means and the amount of heat acquired by the outflow acquisition means is calculated. The calculated balance is graphically displayed on the display screen. Therefore, the material balance or the heat balance can be easily ascertained.

According to the operation status monitoring method of the present disclosure, a balance between the amount of material acquired by the inflow acquisition means and the amount of material acquired by the outflow acquisition means is calculated, or a balance between the amount of heat acquired by the inflow acquisition means and the amount of heat acquired by the outflow acquisition means is calculated. The calculated balances are graphically displayed on the display screen. Therefore, the material balance or the heat balance can be easily ascertained.

Hereinafter, embodiments of the operation status monitoring apparatus according to the present disclosure will be explained.

### First Embodiment

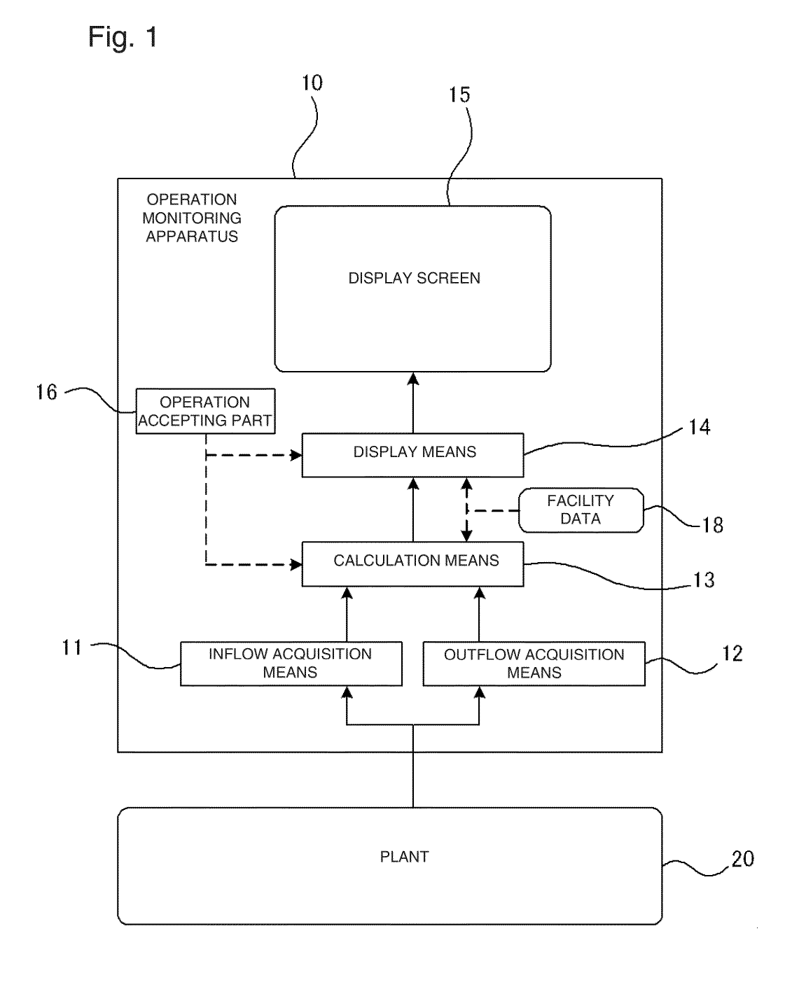

FIG. 1 is a block diagram illustrating a constitution of an operation status monitoring apparatus according to the first embodiment. The operation status monitoring apparatus of the present embodiment is a portion of an operation monitoring apparatus. The operation monitoring apparatus is used for monitoring the operation status of a plant via a display screen.

As shown in FIG. 1, an operation monitoring apparatus 10 has an inflow acquisition means 11, an outflow acquisition means 12, a calculation means 13, a display means 14, and an operation accepting part 16. The inflow acquisition means 11 acquires the amount of material or amount of heat flowing into a predetermined region of plant facilities disposed in a plant 20. The outflow acquisition means 12 acquires the amount of material or amount of heat flowing out from the predetermined region. The calculation means 13 calculates a balance between the amount of material acquired by the inflow acquisition means 11 and the amount of material acquired by the outflow acquisition means 12. Alternatively, the calculation means 13 calculates a balance between the amount of heat acquired by the inflow acquisition means 11 and the amount of heat acquired by the outflow acquisition means 12. The display means 14 graphically displays the balance calculated by the calculation means 13 on a display screen 15. The operation accepting part 16 accepts an operational request of a user.

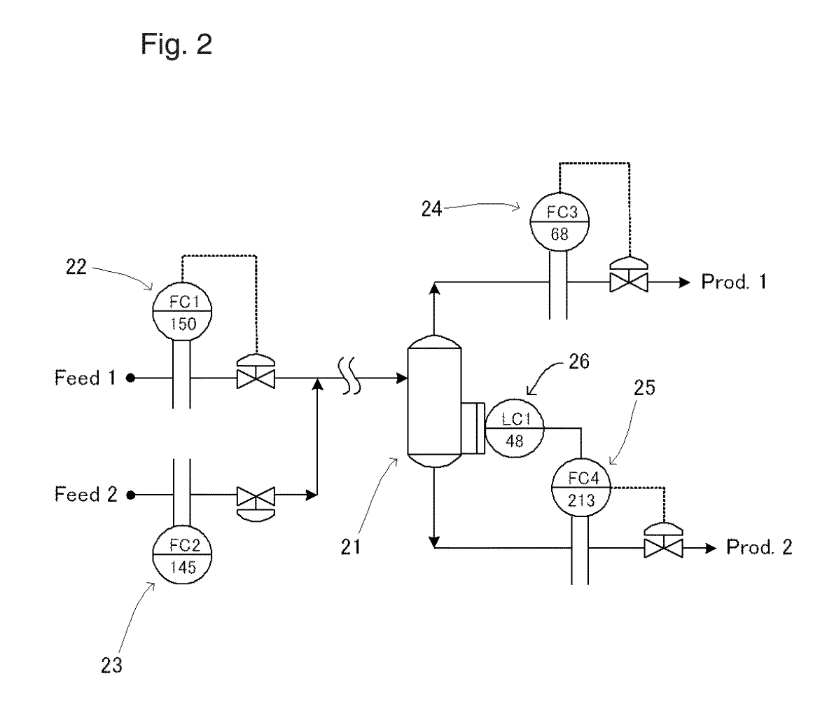

FIG. 2 illustrates an example of a constitution (process flow) of a portion of the plant facilities disposed in the plant 20 (FIG. 1) graphically displayed on the display screen 15.

In the process example shown in FIG. 2, referring to a device 21, two feeds shown as “Feed 1” and “Feed 2” are fed into the device 21. Further, two products shown as “Prod. 1” and “Prod. 2” are produced by the device 21. The flow amount of “Feed 1” is measured by a flowmeter 22, the flow amount of the “Feed 2” is measured by a flowmeter 23, the flow amount of “Prod. 1” is measured by a flowmeter 24, and the flow amount of “Prod. 2” is measured by a flowmeter 25. The numerical values shown together with the flowmeters, such as “150” in the flowmeter 22 and “145” in the flowmeter 23, indicate the flow amounts measured by the respective flowmeters. The symbols shown together with the measurement instruments including the flowmeters, such as “FC1” in the flowmeter 22 and “FC2” in the flowmeter 23, indicate tag names of the measurement instruments.

Next, the operation of the operation status monitoring apparatus of the present embodiment will be explained.

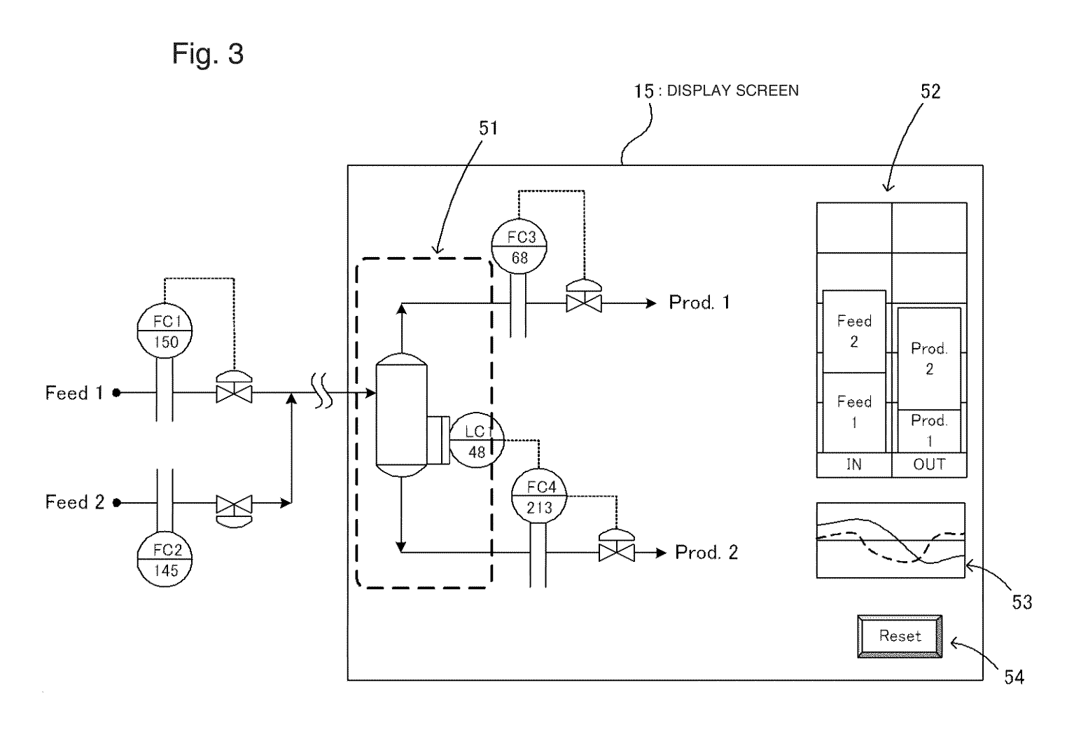

FIG. 3 illustrates an example of a portion of plant facilities shown in FIG. 2 graphically displayed on the display screen 15. In the operation monitoring apparatus 10, facility data 18 (FIG. 1), which is information of the plant facilities disposed in the plant 20, is stored. Based on the facility data 18, the statuses (process flow) of the plant facilities are displayed by the display means 14. A user can freely set a region of the plant facilities displayed on the display screen 15 by an instruction via the operation accepting part 16 or the display screen 15. When an instruction of the user to the operation accepting part 16 or to the display screen 15 is accepted, the display means 14 searches the facility data 18 in accordance with the instruction. As a result, the statuses of the plant facilities in the instructed region are read by the display means 14 and graphically displayed on the display screen 15. Further, process values measured by sensors within the instructed region (for example, flow amounts of the flowmeters 22, 23, 24, and 25) are appropriately read by the display means 14 via the inflow acquisition means 11, the outflow acquisition means 12, and the calculation means 13 and then displayed on the display screen 15.

In FIG. 3, the graphical display of the plant facilities is continuously portrayed up to the outside of the display screen 15. This is to illustrate the correspondence relationship between the plant facilities shown in FIG. 2 and the display regions on the display screen 15.

As shown in FIGS. 2 and 3, a region of a portion including the device 21 of the plant facilities shown in FIG. 2 is graphically displayed on the display screen 15 (FIG. 3).

When a user wants to know a balance between an amount of inflow material and outflow material (hereinafter referred to as “material balance”) of the device 21, the user designates the device 21 displayed on the display screen 15 by an instruction via the operation accepting part 16 or the display screen 15. Thereby, the calculation means 13 can calculate the material balance of the designated range. Further, the calculation result can be displayed on the display screen 15. For example, in FIG. 3, a display frame 51 surrounding the device 21 indicates that the device 21 (FIG. 2) has been designated. In this case, the material balance in the device 21 is displayed on a graph in a region 52 of the display screen 15. Further, an index value history (change over time) related to the material balance is displayed on a trend graph in a region 53 of the display screen 15. Finally, a reset button is displayed in a region 54. The reset button is a button for resetting the integrated value, which is one of the index values displayed in the region 53. The integrated value will be explained below.

The calculation range of the material balance is not limited to a single device, and can be designated as a wide range in accordance with a plurality of devices and/or facilities. In this case, for example, a wide range can be designated by an operation such as widening the display frame 51. If a region of the plant facilities displayed on the display screen 15 is set, a main device within this region can be automatically set as the calculation range of the material balance.

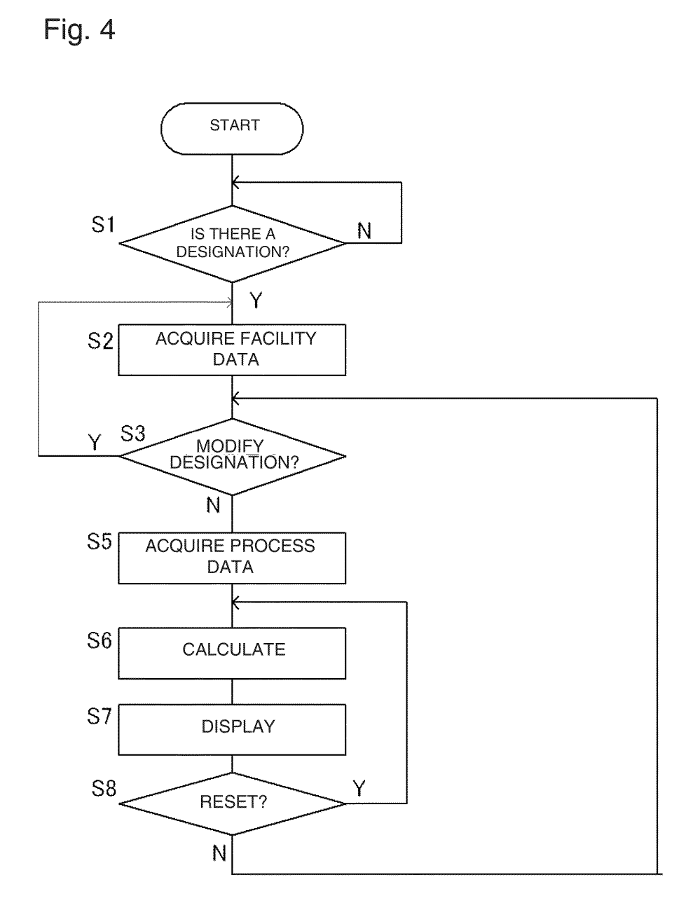

FIG. 4 is a flowchart illustrating the operation of the operation monitoring device 10 related to the calculation and display of the material balance.

In step S1 of FIG. 4, the calculation means 13 waits for a calculation range of the material balance to be designated, and then proceeds to step S2.

In step S2, the calculation means 13 accesses the facility data 18 and acquires information used in the calculation of the material balance. This information includes information used for calculating the material balance for the designated calculation range. For example, if the device 21 has been designated, the information includes calculation formulas using the flow amounts of “Feed 1”, “Feed 2”, “Prod. 1”, and “Prod. 2” and/or information stating that the flow amounts are obtained as flow amounts of the flowmeters 22, 23, 24, and 25.

Next, in step S3, it is determined whether the calculation range of the material balance has been modified. If YES, the calculation means 13 returns to step S2 and acquires information used in the calculation of the material balance for the modified calculation range. On the other hand, If NO is determined in step S3, the calculation means 13 proceeds to step S5.

In step S5, the calculation means 13 acquires the most recent process values for use in the calculation of the material balance via the inflow acquisition means 11 and the outflow acquisition means 12 based on the information acquired in step S2. For example, if the device 21 has been designated, the flow amounts of the flowmeters 22 and 23 are acquired via the inflow acquisition means 11. Further, the flow amounts of the flowmeters 24 and 25 are acquired via the outflow acquisition means 12.

Next, in step S6, the calculation means 13 executes an arithmetic operation for calculating the material balance based on the information acquired in step S2 and the process values acquired in step S5. Here, the following are calculated: the total material inflow amount for the designated calculation range of the material balance, the total material outflow amount from the calculation range, the difference between the total inflow amount and the total outflow amount, the integrated value (time-integrated value) of the difference, and the like.

Next, in step S7, the calculation result in step S6 is graphically displayed on the display screen 15 by the display means 14.

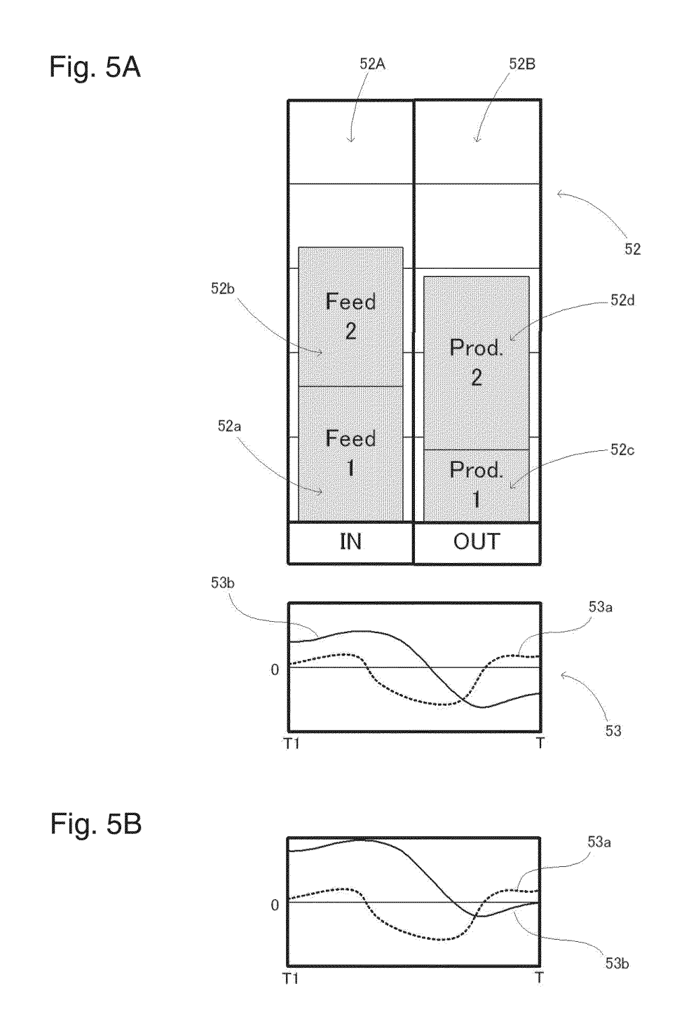

FIG. 5A is a diagram illustrating an example of the graphical displays displayed in the region 52 and the region 53 of the display screen 15 in step S7.

As shown in FIG. 5A, in this example, the device 21 is designated as the calculation range of the material balance. In this case, in a region 52A on the left side within the region 52 of the display screen 15, a bar 52a showing the flow amount (150 kl/h) of the flowmeter 22, which is the material inflow amount, and a bar 52b showing a flow amount (145 kl/h) of the flowmeter 23 are stacked on each other. Thereby, a bar showing the total inflow amount (295 kl/h) is displayed. Meanwhile, in a region 52B on the right side within the region 52 of the display screen 15, a bar 52c showing the flow amount (68 kl/h) of the flowmeter 24, which is the material outflow amount, and a bar 52d showing the flow amount (213 kl/h) of the flowmeter 25 are stacked on each other. Thereby, a bar showing the total outflow amount (281 kl/h) is displayed.

In this way, the total inflow amount into the device 21 and the total outflow amount from the device 21 are displayed side-by-side from left to right. Therefore, it is immediately clear whether the inflow amount and the outflow amount are balanced or unbalanced. As a result, it can be easily recognized whether the material balance is normal or abnormal. For example, in the example in FIG. 5A, the bar in the region 52A that shows the total inflow amount rises slightly higher than the bar in the region 52B that shows the total outflow amount. Therefore, it can be ascertained that the inflow amount is slightly higher than the outflow amount in the device 21.

As explained above, in the example of FIG. 5A, the device 21 is designated as the calculation region of the material balance. In this case, in the region 53 of the display screen 15, a change over time in the difference between the total inflow amount and the total outflow amount (for example, “total inflow amount”−“total outflow amount”) is displayed as a trend graph 53a in which the time is on the horizontal axis. Further, a change over time in the integrated value (time-integrated value) of the difference between the total inflow amount and the total outflow amount is displayed as a trend graph 53b. These trend graphs indicate the change from a past time T1 to a current time T.

In this way, the difference between the total inflow amount and the total outflow amount and the integrated value of the difference are displayed as trend graphs. Therefore, a change in the balance or unbalance between the inflow amount and the outflow amount can be immediately confirmed. In particular, the integrated value of the difference between the total inflow amount and the total outflow amount is an index that accurately indicates the material balance within a fixed period of time. Therefore, a change in the integrated value can be easily ascertained from the display of the trend graphs, and this is extremely useful. For example, by monitoring the integrated value, dangerous conditions or the like such as overflow of a material that has gradually accumulated over a long period of time in the device can be detected. Further, abnormalities in the measurement instruments can also be easily ascertained.

Also, the period for displaying the integrated value, or in other words the period of time from the time T1 to the current time T in FIG. 5A, can be freely set. As a result, it is possible to monitor the material balance from various points of view.

Next, in step S8 of FIG. 4, it is determined whether an operation on the reset button displayed in the region 54 of the display screen 15 has been performed. If YES, the operation returns to step S6, and if NO, the operation returns to step S3.

If YES is determined in step S8, the current value of the integrated value displayed as the trend graph 53b in step S6 is reset to zero.

FIG. 5B is a diagram illustrating a display status of the trend graph 53b when the reset button is operated in the state shown in FIG. 5A.

If the reset button displayed in the region 54 is operated, in step S6, the calculation means 13 shifts the integrated value so that the current value of the integrated value becomes zero. Thereby, as shown in FIGS. 5A and 5B, the entire trend graph 53b displayed by the display means 14 is shifted in parallel in the up or down direction (step S7) and changes the display status so that the value at the current time T indicates zero (FIG. 5B). Errors in the measurement instruments are also accumulated in the integrated value. Therefore, there is a possibility that the integrated value may go beyond the display range due to such errors. Thus, in the present embodiment, the display range of the integrated value can be easily appropriately adjusted by operating the reset button. Also, a change in the integrated value from the reset time can be accurately ascertained by operating the reset button.

A setting can be made so that an alarm is generated if the difference between the total inflow amount and the total outflow amount or the integrated value of this difference exceeds a certain value. Thereby, the burden of the monitoring tasks can be lightened. For example, if the difference between the inflow amount and the outflow amount in the device 21 or the integrated value of this difference increases, it is expected that the retention of the material will change in the calculation range of the material balance. However, if the measurement value of a drum level gauge 26 (FIG. 2) does not exhibit rational movement when an alarm is generated, it is assumed that there is an abnormality in one of the measurement instruments. In this way, by monitoring the balance between the inflow amount and the outflow amount, the capability to detect abnormalities in the plant can be improved.

In the above embodiment, the balance and unbalance of the inflow amount and the outflow amount was displayed with a bar graph. The present embodiment is not limited thereto, and a bar showing an integrated value (time-integrated value) of the inflow amount for a certain period of time and a bar showing an integrated value (time-integrated value) of the outflow amount for a certain period of time can be displayed next to each other. There are cases in which the balance status between the integrated value of the inflow amount and the integrated value of the outflow amount over a certain period of time is more important information than the instantaneous balance status between the inflow amount and the outflow amount. In such cases, the balance status of the integrated values can be displayed with a bar graph. Of course, the instantaneous balance status between the inflow amount and the outflow amount and the balance status between the integrated value of the inflow amount and the integrated value of the outflow amount can be displayed together.

In the above embodiment, a numerical value indicating the material balance was graphically displayed next to a corresponding device in a region of the plant facilities. The present embodiment is not limited thereto, and the numerical value indicating the material balance can be graphically displayed by overlaying it on the corresponding device in a region of the plant facilities.

As described above, in the above embodiment, the material balance is nearly constantly indicated on the display screen by a graphical display with high visibility. Thereby, an operator can easily recognize a collapse in the material balance. For example, if a defect occurs in a level gauge, the operator can rapidly detect an abnormality. The operator can detect not only the abnormality in the level gauge, but can also easily detect a process abnormality such as leakage from a pipe. Thereby, the monitoring burden on the operator can be lightened. As a result, safer operation can be realized.

### Second Embodiment

An operation status monitoring apparatus of the second embodiment graphically displays a heat balance. The operation status monitoring apparatus of this embodiment is a portion of an operation monitoring apparatus. The operation monitoring apparatus is used for monitoring the operation status of a plant via a display screen.

Heat may escape to the outside of a system due to heat release from a device. For example, if a device being monitored is a reactor, it generates reaction heat. Therefore, it is much more difficult to achieve a heat balance than a material balance. Further, the device itself has a heat capacity. Thus, it takes time from when heat is supplied to the device until the temperature of the device changes. Therefore, when the system is changing dynamically, the heat balance is not achieved. Although these factors of uncertainty exist, a graphical display of the heat balance with the material balance can provide various information that is useful for monitoring.

Below, the operation status monitoring apparatus of the second embodiment will be explained referring to FIGS. 1, 3, 6, 7A and 7B, with a focus on how it differs from the first embodiment.

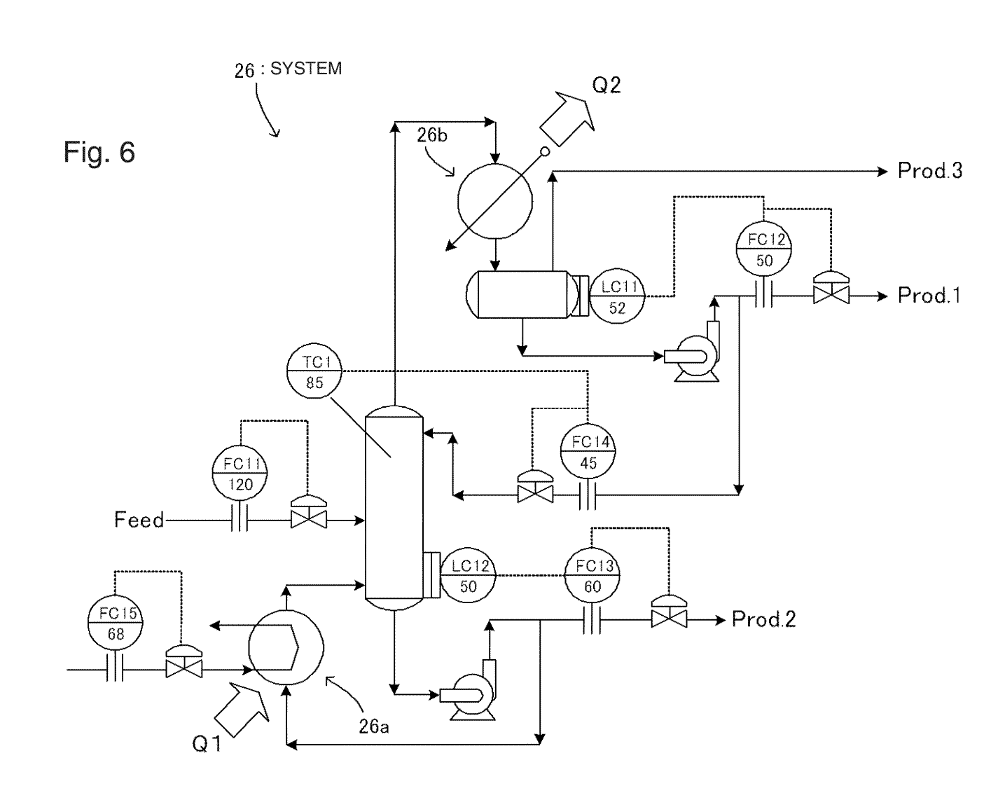

FIG. 6 illustrates an example of a constitution (process flow) of a portion of the plant facilities disposed in the plant 20 (FIG. 1). Similar to the first embodiment, this graphical display is displayed on the display screen 15 by the display means 14.

In the process example shown in FIG. 6, referring to the heat balance of a system (distillation column) 26 shown in FIG. 6, the amount of heat entering the system 26 is the sum of an external heat amount Q1 provided by a reboiler 26a and enthalpy of a feed indicated as “Feed”. On the other hand, the amount of heat exiting the system 26 is the sum of heat Q2 removed by an overhead cooler 26b and enthalpy carried away from the system 26 by three types of products indicated as “Prod. 11”, “Prod. 12”, and “Prod. 13”.

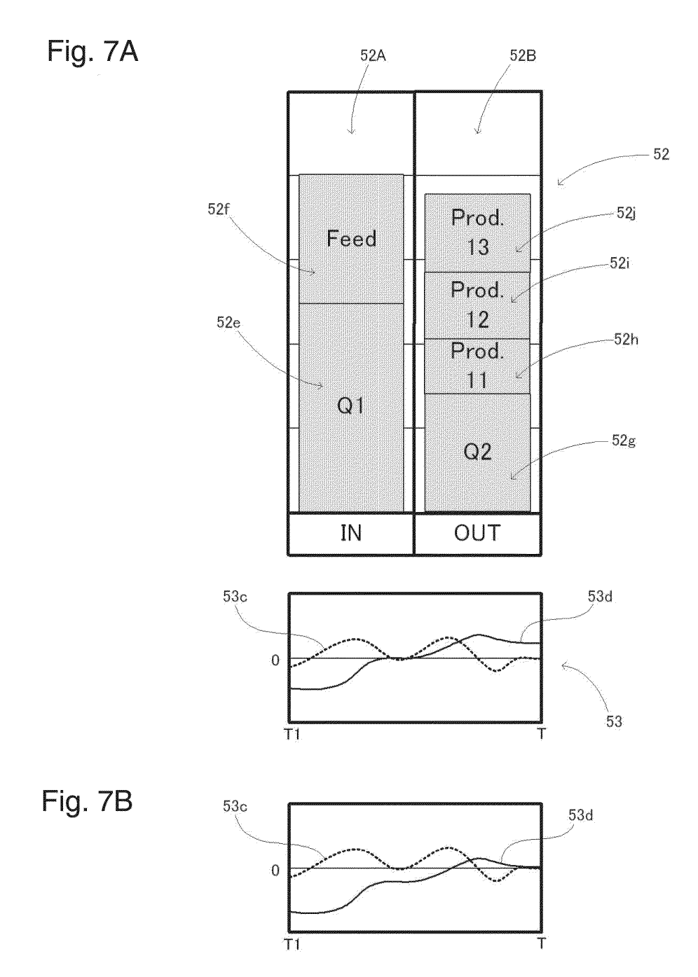

FIG. 7A is a diagram illustrating an example of the graphical display showing the heat balance of the system 26. Similar to the first embodiment, this graphical display is displayed on the display screen 15 by the display means 14.

Among the calculations used in the graphical display shown in FIG. 7A, the amount of heat entering the system 26 is calculated by the inflow acquisition means 11 and the calculation means 13 and the amount of heat exiting the system 26 is calculated by the outflow acquisition means 12 and the calculation means 13. The parameters used in calculating the inflow/outflow of enthalpy include measurement values (temperature, pressure, and flow amount) obtained from the measurement instruments of the plant 20.

In the example shown in FIG. 7A, in a region 52A on the left side within the region 52 (FIG. 3) of the display screen 15, a bar 52e showing the external heat amount Q1 provided by the reboiler 26a and a bar 52f showing the enthalpy of a feed indicated as “Feed” are stacked on each other. Thereby, a bar showing the total heat amount of the above, or in other words the amount of heat entering the system 26, is displayed. Meanwhile, in a region 52B on the right side within the region 52 of the display screen 15, a bar 52g showing the heat Q2 removed by the overhead cooler 26b, and bars 52h, 52i, and 52j showing the enthalpy carried away from the system 26 by the three types of products indicated as “Prod. 11”, “Prod. 12”, and “Prod. 13” are stacked on each other. Thereby, a bar showing the total heat amount of the above, or in other words the amount of heat exiting the system 26, is displayed.

In this way, the total amount of heat entering the system 26 and the total amount of heat exiting the system 26 are displayed side-by-side from left to right. Therefore, it is immediately clear whether the amount of heat entering and the amount of heat exiting are balanced or unbalanced. As a result, it can be easily recognized whether the heat balance is normal or abnormal. For example, in the example in FIG. 7A, the bar in the region 52A that shows the total amount of heat entering rises slightly higher than the bar in the region 52B that shows the total amount of heat exiting. Therefore, it can be ascertained that the amount of heat entering is slightly higher than the amount of heat exiting in the system 26. In other words, the level difference between the top edge of the bar in the region 52A and the top edge of the bar in the region 52B directly indicates the final heat balance.

As shown in FIG. 7A, in the region 53 (FIG. 3) of the display screen 15, a change over time in the difference between the amount of heat entering and the amount of heat exiting in the system 26 is displayed as a trend graph 53c in which the time is on the horizontal axis. Further, a change over time in the integrated value (time-integrated value) of the difference is displayed as a trend graph 53d. These trend graphs indicate the change from a past time T1 to a current time T.

In this way, the difference between the amount of heat entering and the amount of heat exiting and the integrated value of the difference are displayed as trend graphs. Therefore, a change in the balance or unbalance between the amount of heat entering and the amount of heat exiting can be immediately confirmed. In particular, the integrated value of the difference between the amount of heat entering and the amount of heat exiting is an index that indicates the amount of heat accumulated or released within a fixed period of time. Therefore, a change in the integrated value can be easily ascertained from the display of the trend graphs, and this is extremely useful. For example, the amount of excessive heat added into a system is normally detected as a rise in the temperature and/or a rise in the pressure within the system. If there are defects in these measurement instruments, the system may be damaged. Similar to monitoring the material balance, monitoring the heat balance can serve as a backup of the measurement instruments and contribute to early discovery of process abnormalities and the like. Further, by analyzing the heat balance, opportunities for energy conservation can be discovered.

By making the period for displaying the integrated value selective, or in other words, by changing the starting time T1 and the ending time T in FIG. 7A, it is possible to monitor the heat balance in various period of time.

A setting can be made so that an alarm is generated if the difference between the amount of heat entering and the amount of heat exiting or the integrated value of the difference exceeds a certain value. Thus, the burden of plant monitoring can be lightened.

Similar to the first embodiment, in the present embodiment, the display of the integrated value of the difference between the amount of heat entering and the amount of heat exiting can be reset.

FIG. 7B is a diagram illustrating a display status of the trend graph 53d when the reset button in the region 54 (FIG. 3) is operated in the state shown in FIG. 7A.

If the reset button displayed in the region 54 is operated, the calculation means 13 shifts the integrated value so that the current value of the integrated value becomes zero. Thereby, as shown in FIGS. 7A and 7B, the entire trend graph 53d displayed by the display means 14 is shifted in parallel in the up or down direction and changes the display status so that the value at the current time T indicates zero (FIG. 7B). Errors in the measurement instruments are also accumulated in the integrated value. Therefore, there is a possibility that the integrated value may go beyond the display range due to such errors. Thus, the display range of the integrated value can be easily appropriately adjusted by operating the reset button. Also, a subsequent change in the absolute value of the integrated value can be accurately ascertained by operating the reset button when the process sits quietly.

In the above embodiment, the balance or unbalance of the amount of heat entering and the amount of heat exiting was displayed with a bar graph. The present embodiment is not limited thereto, and a bar showing an integrated value (time-integrated value) of the amount of heat entering for a certain period of time and a bar showing an integrated value (time-integrated value) of the amount of heat exiting for a certain period of time can be displayed next to each other. In particular, regarding the heat balance, there are many cases in which the balance status between the integrated value of the amount of heat entering and the integrated value of the amount of heat exiting over a certain period of time is more important information than the instantaneous balance status between the amount of heat entering and the amount of heat exiting. In such cases, the balance status of the integrated values can be displayed with a bar graph. Of course, the instantaneous balance status between the amount of heat entering and the amount of heat exiting and the balance status between the integrated value of the amount of heat entering and the integrated value of the amount of heat exiting can be displayed together.

In the above embodiment, a numerical value indicating the heat balance was graphically displayed next to a corresponding device in a region of the plant facilities. The present embodiment is not limited thereto, and the numerical value indicating the heat balance can be graphically displayed by overlaying it on the corresponding device in a region of the plant facilities.

As described in the above embodiment, the heat balance is nearly constantly indicated on the display screen by a graphical display with high visibility. Thereby, an operator can easily recognize a collapse in the heat balance.

In the embodiments explained above, the material balance or the heat balance was expressed by bar graphs lined up side-by-side from left to right. However, the mode of the graphical display showing the material balance or the heat balance is arbitrary.

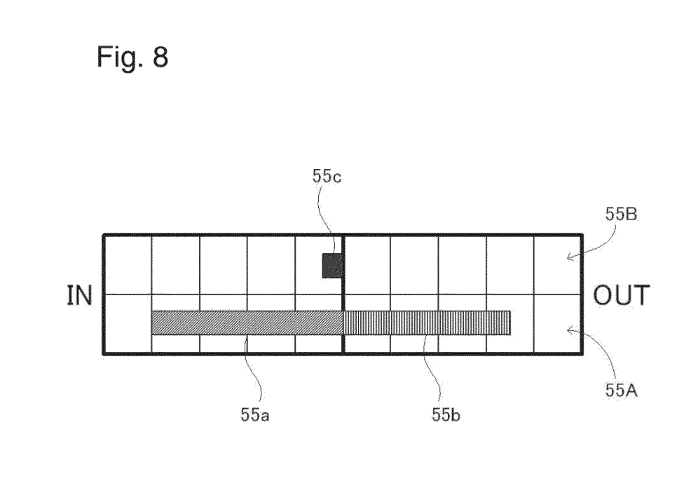

FIG. 8 is a diagram illustrating an example of another graphical display showing material balance.

In the example of FIG. 8, in a region 55A in the lower half of the display portion, an instantaneous value of the material balance is shown. On the other hand, in a region 55B in the upper half, a difference in the material balance is shown. In the example of FIG. 8, a bar 55a that extends to the left side from the center portion of the region 55A indicates the material inflow amount, and a bar 55b that extends to the right side from the center portion of the region 55A indicates the material outflow amount. Further, a bar 55c displayed in the region 55B indicates the difference between the inflow amount and the outflow amount. The direction in which the bar 55c extends is switched between left and right depending on whether the difference is positive or negative. Thereby, the balance status can be instantaneously ascertained. In the embodiment shown in FIG. 8, the bar 55c extends to the left side from the center portion of the display. Therefore, it can be clearly recognized that the inflow amount is greater than the outflow amount. The inflow amount and the outflow amount within a certain period of time or the integrated value of the difference between the inflow amount and the outflow amount can also be simultaneously displayed. Further, the heat balance can also be similarly displayed.

The applicable scope of the present disclosure is not limited to the above-described embodiments. The present disclosure is widely applicable to an operation status monitoring apparatus and the like for monitoring the operation status of a plant via a display screen.

The Operation Monitoring Apparatus 10 includes a central processing unit (CPU), a computer, a computer unit, a data processor, a microcomputer, microelectronics device, or a microprocessor. A person of ordinary skill in the art will also understand that a computer includes at least a program counter, an arithmetic logic unit and a memory, which includes, but is not limited to a read/write memory, read only memory (ROM), random access memory (RAM), DRAM, SRAM etc.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An operation status monitoring apparatus for monitoring an operation status of a plant via a display screen, comprising:
an inflow acquisition means that acquires an amount of material or heat flowing into a predetermined region of plant facilities,
an outflow acquisition means that acquires an amount of material or heat flowing out of the predetermined region,
a calculation means that calculates a balance between the amount of material acquired by the inflow acquisition means and the amount of material acquired by the outflow acquisition means or a balance between the amount of heat acquired by the inflow acquisition means and the amount of heat acquired by the outflow acquisition means, and
a display means that graphically displays the balance calculated by the calculation means on the display screen.

2. The operation status monitoring apparatus according to claim 1, wherein the calculation means calculates as the balance an integrated value of a difference between the amount of material acquired by the inflow acquisition means and the amount of material acquired by the outflow acquisition means or an integrated value of a difference between the amount of heat acquired by the inflow acquisition means and the amount of heat acquired by the outflow acquisition means.

3. The operation status monitoring apparatus according to claim 2, further comprising a reset accepting means that accepts an instruction for resetting the calculation means so that the current value of the integrated value becomes zero.

4. The operation status monitoring apparatus according to claim 1, wherein the calculation means continuously calculates the balance, and the display means graphically displays a trend of the balance that is calculated by the calculation means.

5. The operation status monitoring apparatus according to claim 1, wherein the display means graphically displays, on the display screen, a facility from the predetermined region of the plant facilities next to the balance or overlaid on the balance.

6. The operation status monitoring apparatus according to claim 2, wherein the display means graphically displays, on the display screen, a facility from the predetermined region of the plant facilities next to the balance or overlaid on the balance.

7. The operation status monitoring apparatus according to claim 3, wherein the display means graphically displays, on the display screen, a facility from the predetermined region of the plant facilities next to the balance or overlaid on the balance.

8. The operation status monitoring apparatus according to claim 4, wherein the display means graphically displays, on the display screen, a facility from the predetermined region of the plant facilities next to the balance or overlaid on the balance.

9. The operation status monitoring apparatus according to claim 1, further comprising a region accepting means that accepts an instruction for setting the predetermined region via an operation on a graphical display of the plant facilities displayed on the display screen.

10. The operation status monitoring apparatus according to claim 2, further comprising a region accepting means that accepts an instruction for setting the predetermined region via an operation on a graphical display of the plant facilities displayed on the display screen.

11. The operation status monitoring apparatus according to claim 3, further comprising a region accepting means that accepts an instruction for setting the predetermined region via an operation on a graphical display of the plant facilities displayed on the display screen.

12. The operation status monitoring apparatus according to claim 4, further comprising a region accepting means that accepts an instruction for setting the predetermined region via an operation on a graphical display of the plant facilities displayed on the display screen.

13. The operation status monitoring apparatus according to claim 5, further comprising a region accepting means that accepts an instruction for setting the predetermined region via an operation on a graphical display of the plant facilities displayed on the display screen.

14. The operation status monitoring apparatus according to claim 6, further comprising a region accepting means that accepts an instruction for setting the predetermined region via an operation on a graphical display of the plant facilities displayed on the display screen.

15. The operation status monitoring apparatus according to claim 7, further comprising a region accepting means that accepts an instruction for setting the predetermined region via an operation on a graphical display of the plant facilities displayed on the display screen.

16. The operation status monitoring apparatus according to claim 8, further comprising a region accepting means that accepts an instruction for setting the predetermined region via an operation on a graphical display of the plant facilities displayed on the display screen.

17. An operation status monitoring method for monitoring an operation status of a plant using a display screen, comprising the steps of:
an inflow acquisition step for acquiring electronically by way of a computer an amount of material or heat flowing into a predetermined region of plant facilities,
an outflow acquisition step for acquiring electronically by way of the computer an amount of material or heat flowing out of the predetermined region,
a calculation step for calculating, using the computer, a balance between the amount of material acquired in the inflow acquisition step and the amount of material acquired in the outflow acquisition step or a balance between the amount of heat acquired in the inflow acquisition step and the amount of heat acquired in the outflow acquisition step, and
a display step for graphically displaying the balance calculated in the calculation step on the display screen.

18. The operation status monitoring method according to claim 17, wherein in the calculation step, an integrated value of a difference between an amount of material acquired in the inflow acquisition step and an amount of material acquired in the outflow acquisition step or an integrated value of a difference between an amount of heat acquired in the inflow acquisition step and an amount of heat acquired in the outflow acquisition step is calculated as the balance.

19. A non-transitory computer-readable storage medium with an executable operation status monitoring program stored thereon, wherein the program instructs a microprocessor to perform the following steps:
an inflow acquisition step for acquiring an amount of material or heat flowing into a predetermined region of plant facilities,
an outflow acquisition step for acquiring an amount of material or heat flowing out of the predetermined region,
a calculation step for calculating a balance between the amount of material acquired in the inflow acquisition step and the amount of material acquired in the outflow acquisition step or a balance between the amount of heat acquired in the inflow acquisition step and the amount of heat acquired in the outflow acquisition step, and
a display step for graphically displaying the balance calculated in the calculation step on a display screen.

20. The non-transitory computer-readable storage medium according to claim 19, wherein in the calculation step, an integrated value of a difference between an amount of material acquired in the inflow acquisition step and an amount of material acquired in the outflow acquisition step or an integrated value of a difference between an amount of heat acquired in the inflow acquisition step and an amount of heat acquired in the outflow acquisition step is calculated as the balance.
